(19) United States
(12) Patent Application Publication
(10) Pub. No.: US 2021/0349564 A1
(43) Pub. Date: Nov. 11, 2021

(54) ELECTRONIC DEVICE WITH FINGERPRINT SENSING FUNCTION

(71) Applicant: Egis Technology Inc., Taipei (TW)

(72) Inventors: Yao-Li Huang, Taipei (TW); Yu-Hsuan Lin, Taipei (TW); Sheng Ruei Hsu, Taipei (TW)

(73) Assignee: Egis Technology Inc., Taipei (TW)

(21) Appl. No.: 17/243,588

(22) Filed: Apr. 29, 2021

Related U.S. Application Data
(60) Provisional application No. 63/021,079, filed on May 6, 2020.

(51) Int. Cl. G06F 3/041; G06K 9/00; G09G 3/20

(52) U.S. Cl. CPC G06F 3/0412; G06K 9/0004; G09G 2310/0297; G09G 3/2003; G09G 3/2074

(57) ABSTRACT

An electronic device is provided. A touch display panel includes a pixel array and a plurality of fingerprint sensing pixels. The fingerprint sensing pixels are embedded in the pixel array and located in a non-luminous area outside positions of the sub-display pixels. A display driving circuit is coupled to a plurality of display data lines through a first pin to drive the sub-display pixels to display an image frame. A fingerprint sensing circuit is coupled to a sensing data line through a second pin, and receives fingerprint sensing signals of the fingerprint sensing pixels.

### CROSS-REFERENCE TO RELATED APPLICATION

This application claims the priority benefit of U.S. application Ser. No. 63/021,079, filed on May 6, 2021. The entirety of the above-mentioned patent application is hereby incorporated by reference herein and made a part of this specification.

### BACKGROUND

### Technical Field

The invention relates to a device, and particularly relates to an electronic device with a fingerprint sensing function.

### Description of Related Art

In recent years, fingerprint recognition technology is widely used in various electronic devices to provide various identity login or identity verification functions. Technical modes of current existing fingerprint recognition include, for example, optical, capacitive, thermosensitive, and ultrasonic modes. In this regard, since a fingerprint sensor of the above technical modes is provided in an electronic device, it is usually necessary that the fingerprint sensor occupies a part of a device volume of the electronic device. Generally, the fingerprint sensor may be disposed in or externally mounted to the electronic device under a screen, on a home button or on a back of a device body, etc. In other words, the fingerprint sensor in general may increase an overall device volume or thickness of the electronic device, and further increase the manufacturing costs of the electronic device.

### SUMMARY

The invention is directed to an electronic device adapted to provide a large-area fingerprint sensing function.

The invention provides an electronic device including a touch display panel, a display driving circuit and a fingerprint sensing circuit. The touch display panel includes a pixel array and a plurality of fingerprint sensing pixels. The pixel array includes a plurality of touch display units, and each of the touch display units includes a plurality of sub-display pixels and at least one fingerprint sensing pixel. The fingerprint sensing pixels are embedded in the pixel array and located in a non-luminous area outside positions of the sub-display pixels. The display driving circuit is coupled to a plurality of display data lines through a first pin, and drives the sub-display pixels to display an image frame. The fingerprint sensing circuit is coupled to a sensing data line through a second pin, and receives fingerprint sensing signals of the fingerprint sensing pixels.

Based on the above description, the electronic device of the embodiment of the invention is adapted to realize a full-screen fingerprint sensing function by forming a plurality of fingerprint sensing pixels in the pixel array of the touch display panel, and respectively transmit a display driving signal and the fingerprint sensing signals through the display data lines and the sensing data line, so as to use the additionally configured sensing data line to transmit the fingerprint sensing signals without affecting an original signal transmission path of the display driving signal. In addition, since the fingerprint sensing pixels are embedded in the touch display panel, the electronic device of the invention may effectively reduce a function module space required by fingerprint sensing, thereby reducing an overall device volume or thickness of the electronic device.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic device according to an embodiment of the invention.

FIG. 2 is a schematic diagram of a touch display panel according to an embodiment of the invention.

FIG. 3 is a schematic diagram of an electronic device according to another embodiment of the invention.

FIG. 4 is a schematic circuit diagram of a display driving circuit according to an embodiment of the invention.

FIG. 5 is a schematic circuit diagram of a fingerprint sensing circuit according to an embodiment of the invention.

FIG. 6 is a schematic diagram of an electronic device according to another embodiment of the invention.

### DESCRIPTION OF THE EMBODIMENTS

Reference will now be made in detail to the present preferred embodiments of the invention, examples of which are illustrated in the accompanying drawings. Wherever possible, components/parts/steps of the same reference numbers are used in the drawings and the description to refer to the same or like parts.

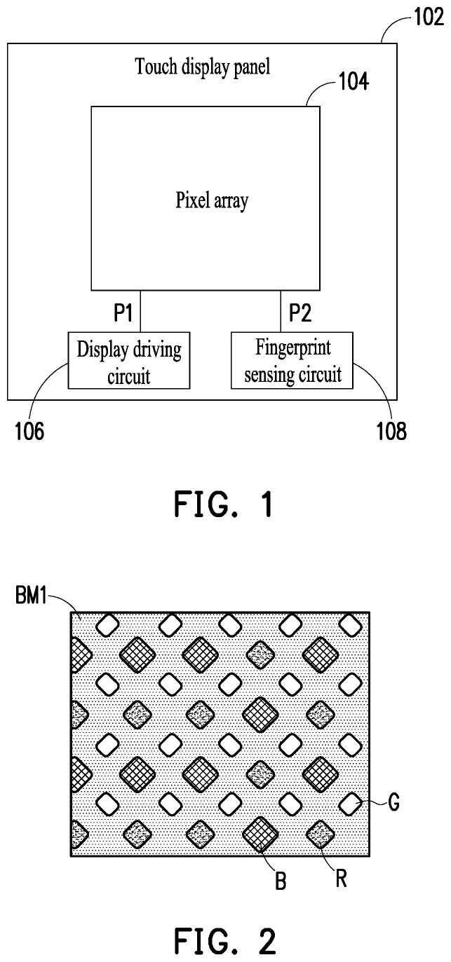

FIG. 1 is a schematic diagram of an electronic device according to an embodiment of the invention. The electronic device may be, for example, a smart phone, a tablet computer, a game console, or other electronic products with a fingerprint recognition function. In the embodiment, the electronic device includes a touch display panel 102, a pixel array 104, a display driving circuit 106, and a fingerprint sensing circuit 108. The pixel array 104 is coupled to the display driving circuit 106 and the fingerprint sensing circuit 108. In the embodiment, the touch display panel 102 may include, for example, an organic light-emitting diode (OLED) display panel, which may include a glass substrate and a touch panel. The pixel array 104 may be formed on the glass substrate in an active area (AA) of the touch display panel 102, the pixel array 104 may include a plurality of touch display units, and each touch display unit may include a plurality of sub-display pixels and at least one fingerprint sensing pixel. In the embodiment, the sub-display pixel may be, for example, an OLED display pixel. The display driving circuit 106 and the fingerprint sensing circuit 108 may be respectively implemented by different integrated chips, and the integrated chips may be disposed in a peripheral area (PA) of the touch display panel 102, but the invention is not limited thereto.

It should be noted that the touch display panel 102 of the embodiment may adopt an in-cell fingerprint, touch and display panel framework, and fingerprint sensing pixels may be embedded in the pixel array 104 and located in a non-luminous area outside positions of the sub-display pixels. For example, as shown in a schematic diagram of a touch display panel of FIG. 2, the touch display panel may include a plurality of sub-display pixels of different colors, such as red sub-display pixels R, green sub-display pixels G, and blue sub-display pixels B, but the invention is not limited thereto. In other embodiments, sub-display pixels of more or fewer colors may also be included. A size of each fingerprint sensing pixel may be greater than, equal to, or smaller than a size of the sub-display pixel. In some embodiments, the fingerprint sensing pixels in the pixel array 104 may have different sizes, and the size of each fingerprint sensing pixel may be related to the sizes of the adjacent sub-display pixels, but the invention is not limited thereto. In addition, an area where the sub-display pixels are not arranged is a black matrix area BM1 formed by a black matrix layer, and the fingerprint sensing pixels may be arranged in the black matrix area BM1 to avoid affecting the display quality.

The display driving circuit 106 may be coupled to a plurality of sub-display pixels in the pixel array 104 through a pin P1, and the fingerprint sensing circuit 108 may be coupled to a plurality of fingerprint sensing pixels in the pixel array 104 through a pin P2. Furthermore, the display driving circuit 106 may be connected to display data lines in the pixel array 104 through the pin P1, and drives the sub-display pixels on the display data lines to display an image frame through the pin P1. The fingerprint sensing circuit 108 may be connected to a sensing data line in the pixel array 104 through the pin P2, so as to receive fingerprint sensing signals from the fingerprint sensing pixels through the sensing data line and the pin P2. In this way, a display driving signal and the fingerprint sensing signals are respectively transmitted through the display data lines and the sensing data line, so as to use the additionally configured sensing data line to transmit the fingerprint sensing signals without affecting an original signal transmission path of the display driving signal. In addition, since the fingerprint sensing pixels are embedded in the touch display panel, the electronic device of the embodiment may effectively reduce a function module space required by fingerprint sensing, thereby reducing an overall device volume or thickness of the electronic device.

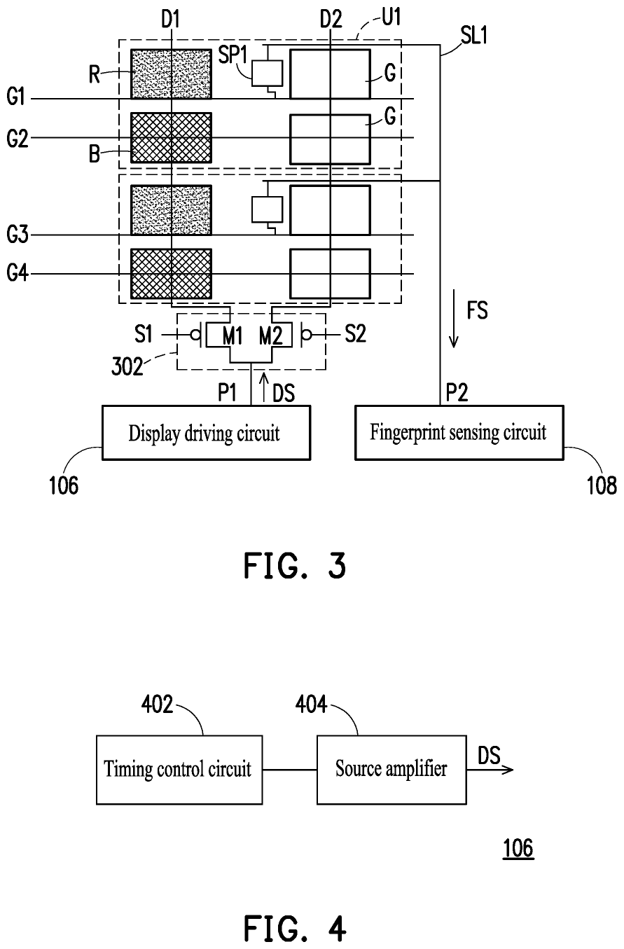

Further, each touch display unit of the pixel array 104 may include a first sub-display pixel that displays a first color, a second sub-display pixel that displays a second color, a third sub-display pixel and a fourth sub-display pixel that display a third color, and a fingerprint sensing pixel. For example, FIG. 3 is a schematic diagram of an electronic device according to another embodiment of the invention. In order to further describe a circuit structure of the touch display unit, FIG. 3 only illustrates a part of the touch display units. In the embodiment of FIG. 3, each touch display unit U1 may include one red sub-display pixel R, two green sub-display pixels G, one blue sub-display pixel B, and one fingerprint sensing pixel SP1, but the invention is not limited thereto.

In some embodiments, in each touch display unit U1, one of the green sub-display pixels G may also be replaced with a white sub-display pixel, but the invention is not limited thereto. In other embodiments, each touch display unit U1 may also include, for example, only one red sub-display pixel R, one green sub-display pixel G, one blue sub-display pixel B, and one fingerprint sensor pixel SP1. The number of the sub-display pixels included in the touch display unit U1 is not limited by the embodiment. In addition, in some embodiments, the sub-display pixels of each touch display unit U1 may be formed on a first semiconductor layer of the touch display panel 102, and the fingerprint sensing pixels may be formed on a second semiconductor layer of the touch display panel 102.

In detail, in the embodiment of FIG. 3, each sub-display pixel may be arranged at an intersection of a corresponding gate line and a display data line, and coupled to the corresponding gate line and display data line. For example, a red sub-display pixel R is disposed at an intersection of a gate line G1 and a display data line D1, and the red sub-display pixel R is coupled to the gate line G1 and the display data line D1, a green sub-display pixel G is disposed at an intersection of the gate line G1 and a display data line D2, and the green sub-display pixel G is coupled to the gate line G1 and the display data line D2. Similarly, the sub-display pixels at the intersections of the gate lines G2-G4 and the display data lines D1-D2 are also respectively coupled to the corresponding gate lines and display data lines, which are not be repeated. The display data lines D1 and D2 may also be coupled to the display driving circuit 106 through a multiplexer circuit 302. In addition, the fingerprint sensing pixel of each touch display unit U1 is coupled to the corresponding gate line, and is coupled to the fingerprint sensing circuit 108 through a sensing data line SL1. For example, in the embodiment of FIG. 3, the gate lines G1 and G3 are also respectively coupled to the corresponding fingerprint sensing pixels SP1.

In the embodiment, the gate lines G1-G4 may be used to receive scan signals to turn on the corresponding sub-display pixels. For example, the gate line G1 may receive a scan signal to turn on the corresponding red sub-display pixel R and the green sub-display pixel G. In addition, since the gate line G1 of the embodiment is also coupled to the fingerprint sensing pixel SP1, so the fingerprint sensing pixel SP1 on the gate line G1 is also enabled to perform fingerprint sensing. The display driving circuit 106 may transmit a display driving signal DS to the display data lines D1 and D2 through the multiplexer circuit 302 to drive the sub-display pixels on the display data lines D1 and D2 to display an image frame.

Further, the multiplexer circuit 302 may include transistors M1 and M2. The transistor M1 is coupled between the display data line D1 and the pin P1, and is controlled by a selection control signal S1 to enter a turn-on state. The transistor M2 is coupled between the display data line D2 and the pin P1, and is controlled by a selection control signal S2 to enter a turn-on state, where the transistor M1 and the transistor M2 are not turned on at the same time. The multiplexer circuit 302 may be controlled by the selection control signals S1 and S2 to output the display driving signal DS to the display data line D1 or D2 according to a display timing of the sub-display pixels on the display data lines D1 and D2 to drive the sub-display pixels on the display data lines D1 and D2 to display the image frame. In this way, by using the multiplexer circuit 302 to switch the display data lines that transmit the display driving signal DS, the number of pins required by the display driving circuit 106 is reduced, thereby reducing the space occupied by the pins in the peripheral area of the panel.

In addition, a fingerprint sensing signal FS generated by the fingerprint sensing pixel SP1 by sensing a fingerprint may be transmitted to the fingerprint sensing circuit 108 through the sensing data line SL1, and the fingerprint sensing circuit 108 generates a corresponding fingerprint sensing image. In this way, by respectively using the display data lines D1 and D2 and the sensing data line SL1 to transmit the display driving signal DS and the fingerprint sensing signal FS, the additionally configured sensing data line SL1 may be used to transmit the fingerprint sensing signal FS without affecting an original signal transmission path of the display driving signal DS.

It should be noted that in some embodiments, the display driving circuit 106 and the fingerprint sensing circuit 108 may be integrated into a same integrated chip. Since the multiplexer circuit 302 of the embodiment may reduce the number of pins required by the display driving circuit 106, when the display driving circuit 106 and the fingerprint sensing circuit 108 are integrated into the same integrated chip, the unused pins saved by using the multiplexer circuit 302 may be used by the fingerprint sensing circuit 108. Therefore, the display driving circuit 106 and the fingerprint sensing circuit 108 may be integrated into the same integrated chip without increasing the number of pins.

In addition, the arrangement of the sub-display pixels of different colors in the invention is not limited to the above description. In addition, the fingerprint sensing pixel SP1 may also be arranged next to any sub-display pixel in each touch display unit U1, and coupled to the gate line corresponding to the sub-display pixel, and is not limited to being arranged next to the green sub-display pixel G as that described in the aforementioned embodiment.

FIG. 4 is a schematic circuit diagram of a display driving circuit according to an embodiment of the invention. Furthermore, the display driving circuit 106 may include a timing control circuit 402 and a source amplifier 404. An input terminal of the source amplifier 404 is coupled to the timing control circuit 402, and an output terminal of the source amplifier 404 is coupled to an input terminal of the multiplexer circuit 302. The timing control circuit 402 may provide a timing control signal to the source amplifier 404, and the source amplifier 404 outputs the display driving signal DS according to a designed display timing of the sub-display pixels.

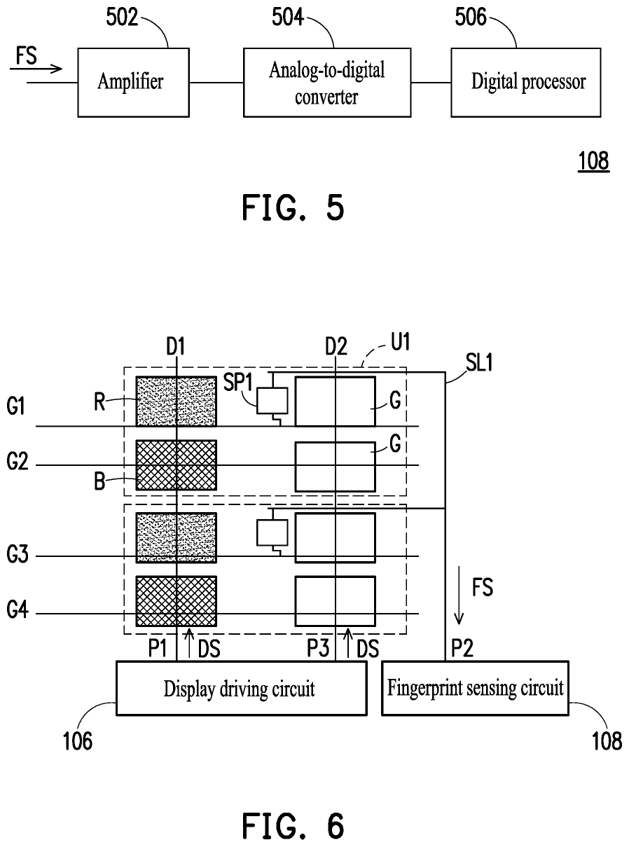

FIG. 5 is a schematic circuit diagram of a fingerprint sensing circuit according to an embodiment of the invention. In the embodiment, the fingerprint sensing circuit 108 may include an amplifier 502, an analog-to-digital converter 504, and a digital processor 506. An input terminal of the amplifier 502 is coupled to the fingerprint sensing pixel SP1 to receive the fingerprint sensing signal FS. An input terminal of the analog-to-digital converter 504 is coupled to an output terminal of the amplifier 502. The digital processor 506 is coupled to an output terminal of the analog-to-digital converter 504. The amplifier 502 may amplify the fingerprint sensing signal FS and provide it to the analog-to-digital converter 504. The analog-to-digital converter 504 may provide a digital signal of a fingerprint sensing result to the digital processor 506, and the digital processor 506 generates fingerprint sensing information such as a fingerprint sensing image according to the digital signal provided by the analog-to-digital converter 504.

It should be noted that in some embodiments, the electronic device may not include the multiplexer circuit 302. For example, FIG. 6 is a schematic diagram of an electronic device according to another embodiment of the invention. A difference between the embodiment and the embodiment of FIG. 3 is that the display driving circuit 106 is directly coupled to the display data lines D1 and D2 through pins P1 and P3, and the display driving circuit 106 may directly output the display driving signal DS to the display data line D1 or D2 to drive the sub-display pixels on the display data lines D1 and D2 to display an image frame.

In summary, the electronic device of the embodiment of the invention is adapted to realize a full-screen fingerprint sensing function by forming a plurality of fingerprint sensing pixels in the pixel array of the touch display panel, and respectively transmit the display driving signal and the fingerprint sensing signals through the display data lines and the sensing data line, so as to use the additionally configured sensing data line to transmit the fingerprint sensing signals without affecting an original signal transmission path of the display driving signal. In addition, since the fingerprint sensing pixels are embedded in the touch display panel, the electronic device of the invention may effectively reduce a function module space required by fingerprint sensing, thereby reducing an overall device volume or thickness of the electronic device.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. An electronic device, comprising:
a touch display panel, comprising a pixel array and a plurality of fingerprint sensing pixels, wherein the pixel array comprises a plurality of touch display units, each of the touch display units comprises a plurality of sub-display pixels and at least one fingerprint sensing pixel, and the fingerprint sensing pixels are embedded in the pixel array and located in a non-luminous area outside positions of the sub-display pixels;
a display driving circuit, coupled to a plurality of display data lines through a first pin, and driving the sub-display pixels to display an image frame; and
a fingerprint sensing circuit, coupled to a sensing data line through a second pin, and receiving fingerprint sensing signals of the fingerprint sensing pixels.

2. The electronic device as claimed in claim 1, wherein each of the touch display units comprises a first sub-display pixel that displays a first color, a second sub-display pixel that displays a second color, and a third sub-display pixel and a fourth sub-display pixel that display a third color, and the display driving circuit is coupled to the first sub-display pixel and the second sub-display pixel of each of the touch display units on a first display data line through the first display data line, and coupled to the third sub-display pixel and the fourth sub-display pixel of each of the touch display units on a second display data line through the second display data line.

3. The electronic device as claimed in claim 2, further comprising:
a multiplexer circuit, having a first output terminal and a second output terminal respectively coupled to the first display data line and the second display data line, and an input terminal coupled to the first pin, wherein the multiplexer circuit selectively outputs a display driving signal provided by the display driving circuit to the first display data line or the second display data line.

4. The electronic device as claimed in claim 3, wherein the multiplexer circuit comprises:
a first transistor, coupled between the first display data line and the first pin, and controlled by a first selection control signal to enter a turn-on state; and
a second transistor, coupled between the second display data line and the first pin, and controlled by a second selection control signal to enter a turn-on state, wherein the first transistor and the second transistor are not turned on at a same time.

5. The electronic device as claimed in claim 2, wherein the display driving circuit is further coupled to the first display data line through the first pin, and is coupled to the second display data line through a third pin.

6. The electronic device as claimed in claim 2, wherein the first color, the second color, and the third color comprise at least one of red, green, blue, and white.

7. The electronic device as claimed in claim 1, wherein the display driving circuit and the fingerprint sensing circuit are integrated into different chips.

8. The electronic device as claimed in claim 1, wherein the display driving circuit and the fingerprint sensing circuit are integrated or packaged into an integrated chip, and the integrated chip comprises a fingerprint touch display driver integrated chip.

9. The electronic device as claimed in claim 1, wherein the fingerprint sensing circuit comprises:
an amplifier, having an input terminal coupled to the sensing data line;
an analog-to-digital converter, having an input terminal coupled to an output terminal of the amplifier; and
a digital processor, coupled to an output terminal of the analog-to-digital converter.

10. The electronic device as claimed in claim 1, wherein the display driving circuit comprises:
a timing control circuit; and
a source amplifier, having an input terminal coupled to the timing control circuit, and an output terminal coupled to the display data lines.

11. The electronic device as claimed in claim 1, wherein the sub-display pixels are formed on a first semiconductor layer of the touch display panel, and the fingerprint sensing pixels are formed on a second semiconductor layer of the touch display panel.

12. The electronic device as claimed in claim 1, wherein the sub-display pixels comprise at least one of at least one red sub-display pixel, at least one green sub-display pixel, at least one blue sub-display pixel, and at least one white sub-display pixel.

13. The electronic device as claimed in claim 1, wherein the non-luminous area is a black matrix area formed by a black matrix layer.

14. The electronic device as claimed in claim 1, wherein a size of each of the fingerprint sensing pixels is greater than or equal to a size of each of the sub-display pixels.

15. The electronic device as claimed in claim 1, wherein a size of each of the fingerprint sensing pixels is smaller than a size of each of the sub-display pixels.

16. The electronic device as claimed in claim 1, wherein the fingerprint sensing pixels have different sizes.

17. The electronic device as claimed in claim 16, wherein the size of each of the fingerprint sensing pixels is related to a size of an adjacent one of the sub-display pixels.
